(19) United States
(12) Patent Application Publication
(10) Pub. No.: US 2022/0124883 A1
(43) Pub. Date: Apr. 21, 2022

(54) AUTOMATIC DISPLAY OF APPLIANCE CONTROL INTERFACE

(71) Applicant: Haier US Appliance Solutions, Inc., Wilmington, DE (US)

(72) Inventors: Jeff Donald Drake, Louisville, KY (US); Michael A. Funk, Louisville, KY (US); Chen Lu, Louisville, KY (US); Yinyin Liang Wright, Louisville, KY (US)

(21) Appl. No.: 17/071,514

(22) Filed: Oct. 15, 2020

(51) Int. Cl. H05B 6/64

(52) U.S. Cl. CPC H05B 6/6435; H04N 7/183; H05B 6/6414; H05B 6/6402

(57) ABSTRACT

A method for operating a door assembly of an appliance, the door assembly including a display and being configured for providing selective access to a cavity of the appliance, the method including determining that the door has been shut, determining that an item is present within the cavity, determining that a primary application is displayed on the display, and displaying a control interface over a sub-portion of the application on the display when the application is displayed on the display.

### FIELD OF THE INVENTION

The present subject matter relates generally to kitchen appliances, and more particularly to display panels of microwaves.

### BACKGROUND OF THE INVENTION

Kitchen appliances can be used by consumers to perform tasks such as heating or cooking food, storing food or supplies, or washing cooking utensils. Recently, interactive modules such as touch displays and the like have been added to certain kitchen appliances. These touch displays may present pictures or videos related to cooking processes, grocery lists, recipes, or even entertainment such as movies or games. In some appliances, such as microwaves, the display may encompass an entire face of the appliance.

However, existing displays are beginning to display large amounts of different information. Accordingly, a kitchen appliance featuring a display screen that is able to automatically switch between display modes would be particularly beneficial. Further, a kitchen appliance featuring a display screen that is able to display a control interface over only a sub-portion of the display screen would be beneficial.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a method for operating a door assembly of an appliance is provided. The door assembly includes a display and is configured for providing selective access to a cavity of the appliance. The method includes determining that the door has been shut, determining that an item is present within the cavity, determining that a primary application is displayed on the display, and displaying a control interface over a sub-portion of the primary application on the display when the application is displayed on the display.

In another exemplary aspect of the present disclosure, a kitchen appliance is disclosed. The kitchen appliance includes a cabinet defining a cavity for receipt of items, a door attached to the cabinet to selectively open and close the cavity, a display provided on the door, and a controller for controlling the display. The controller is configured for determining that the door has been shut, determining that an item is present within the cavity, determining that a primary application is displayed on the display, and displaying a control interface over a sub-portion of the primary application on the display when the application is displayed on the display.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a microwave appliance according to exemplary embodiments of the present disclosure.

FIG. 2 provides a side schematic view of the exemplary microwave of FIG. 1.

FIG. 3 provides a front view of the exemplary microwave of FIG. 1.

FIG. 4 provides a flow chart illustrating a method of operating a microwave according to exemplary embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

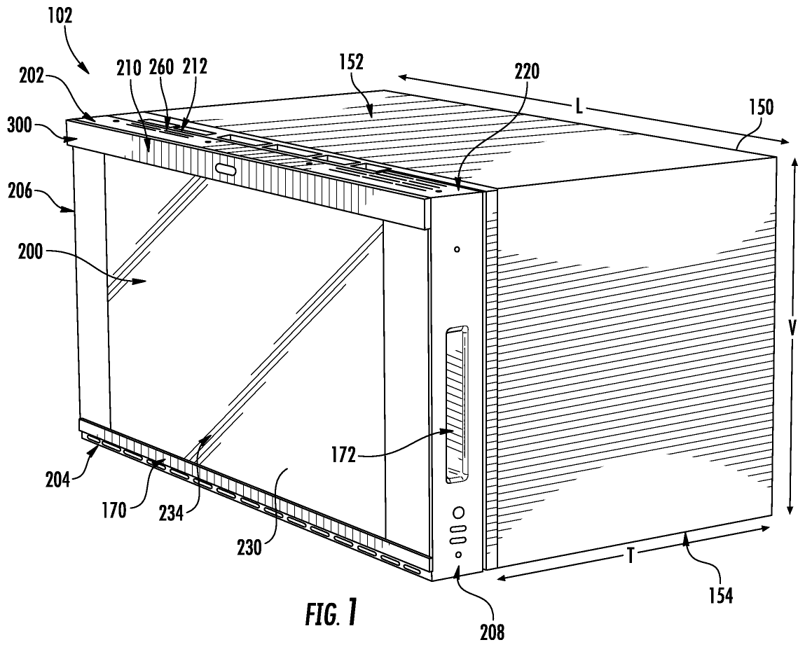

Turning to the figures, FIGS. 1 through 3 provide various views of a microwave appliance 102. Microwave appliance 102 is generally configured to heat articles (e.g., food or beverages) within a cooking chamber 166 using electromagnetic radiation. Microwave appliance 102 may include various components which operate to produce the electromagnetic radiation, as is generally understood. For example, microwave appliance 102 may include a heating assembly 168 having a magnetron (e.g., a cavity magnetron), a high voltage transformer, a high voltage capacitor, and a high voltage diode, as is understood. The transformer may provide energy from a suitable energy source (such as an electrical outlet) to the magnetron. The magnetron may convert the energy to electromagnetic radiation, specifically microwave radiation. The capacitor generally connects the magnetron and transformer, such as via high voltage diode, to a chassis. Microwave radiation produced by the magnetron may be transmitted through a waveguide to cooking chamber 166.

The structure and intended function of microwave ovens or appliances are generally understood by those of ordinary skill in the art and are not described in further detail herein. According to alternative embodiments, microwave appliance 102 may include one or more heating elements, such as electric resistance heating elements, gas burners, other microwave heating elements, halogen heating elements, or suitable combinations thereof, are positioned within cooking chamber 166 for heating cooking chamber 166 and food items positioned therein.

Microwave appliance 102 includes a cabinet 150. Cabinet 150 generally extends between a top end 152 and a bottom end 154 in the vertical direction V, and between a front end 160 and a rear end 162 in the transverse direction T. Cabinet 150 may also generally define cooking chamber 166. Microwave appliance 102 further includes a door assembly 170 that is movably mounted (e.g., rotatably attached) to cabinet 150 in order to permit selective access to cooking chamber 166. Specifically, door assembly 170 can move between an open position (not pictured) and a closed position (e.g., FIG. 1). The open position permits access to cooking chamber 166 while the closed position restricts access to cooking chamber 166. Except as otherwise indicated, with respect to the directions (e.g., the vertical direction V, the lateral direction L, and the transverse direction T), the door assembly 170 is described in the closed position. A handle 172 may be mounted to or formed on door assembly 170 to assist a user with opening and closing door assembly 170. As an example, a user can pull on handle 172 to open or close door assembly 170 and access or cover cooking chamber 166. Additionally, or alternatively, microwave appliance 102 may include a door release button (not pictured) that disengages or otherwise pushes open door assembly 170 when depressed.

Referring now generally to FIGS. 1 through 3, microwave appliance 102 may include an interactive display assembly 200. According to the illustrated embodiment, interactive display 200 is mounted to or within door assembly 170 and defines substantially the entire front surface of door assembly 170. In this regard, door assembly 170 generally extends between a top end 202 and a bottom end 204 along the vertical direction V, between a first side 206 and a second side 208 along the lateral direction L, and between a front side 210 and a rear side 212 along a transverse direction T. As illustrated, interactive display 200 extends along substantially the entire width of door assembly 170 along the lateral direction L (e.g., between the first side 206 and second side 208) and substantially along the entire height of door assembly 170 along the vertical direction V (e.g., between top end 202 and bottom end 204).

According to the illustrated embodiment, door assembly 170 includes a door frame 220 that bounds or supports interactive display 200. Interactive display 200 of door assembly 170 includes an image monitor 230. For instance, image monitor 230 may be mounted to or supported on door assembly 170 proximal to the front side 210 of door assembly 170. Specifically, as illustrated, door assembly 170 may include a monitor cradle that is positioned proximate a front side 210 of door assembly 170 for securely receiving image monitor 230. The monitor cradle may generally be any suitably rigid member mounted to door frame 220 for securing image monitor 230.

Generally, image monitor 230 may be any suitable type of mechanism for visually presenting a digital (e.g., interactive) image. For example, image monitor 230 may be a liquid crystal display (LCD), a plasma display panel (PDP), a cathode ray tube (CRT) display, etc. Thus, image monitor 230 includes an imaging surface 234 (e.g., screen or display panel) at which the digital image is presented or displayed as an optically-viewable picture (e.g., static image or dynamic video) to a user. As illustrated, the imaging surface 234 generally faces, or is directed away from, cooking chamber 166. In particular, the imaging surface 234 is directed toward the area forward from the cooking chamber 166 (e.g., when door assembly 170 is in the closed position). During use, a user standing in front of microwave appliance 102 may thus see the optically-viewable picture (e.g., recipe, dynamic video stream, graphical user interface, etc.) displayed at the imaging surface 234.

The optically-viewable picture at the imaging surface 234 may correspond to any suitable signal or data received or stored by microwave appliance 102 (e.g., at controller 130). As an example, image monitor 230 may present recipe information in the form of viewable text or images. As another example, image monitor 230 may present a remotely captured image, such as a live (e.g., real-time) dynamic video stream received from a separate user or device. As yet another example, image monitor 230 may present a graphical user interface (GUI) (e.g., as part of user interface) that allows a user to select or manipulate various operational features of microwave appliance 102. During use of such GUI embodiments, a user may engage, select, or adjust the image presented at image monitor 230 through any suitable input, such as gesture controls detected through a camera assembly, voice controls detected through one or more microphones, associated touch panels (e.g., capacitance or resistance touch panels) or sensors overlaid across imaging surface 234, etc. According to the illustrated embodiment, image monitor 230 is a tablet or touch screen display that extends an entire width and height of door assembly 170 and provides for an interactive experience to the user of microwave appliance 102. In some embodiments, a control interface 240 may be displayed on image monitor 130. Control interface 240 may be a set of controls for entering or adjusting a cooking operation of microwave appliance 102.

Microwave appliance 102 may include a door sensor 134 provided at the door 170. Additionally or alternatively, door sensor 134 may be provided at cabinet 150 proximate door 170. Door sensor 134 may operate to sense a position of door assembly 170 (i.e., open position, closed position). Door sensor 134 may be any suitable sensor, such as a contact sensor, a hall effect sensor, an optic sensor, or the like. Microwave appliance 102 may further include a camera 136 provided in cavity 166. Camera 136 may be a video camera capable of recording or capturing video of cavity 166. For instance, camera 136 may provide a live feed of cavity 166 and distribute the live feed to interactive display 200, such that a user may view an interior of microwave appliance 102 while microwave appliance 102 is in operation. Camera 136 may be any suitable camera capable of capturing images without interference from other elements of microwave appliance 102 (e.g., heating element 168).

Microwave appliance 102 may include a controller 130 that facilitates operation of microwave appliance 102. In addition, it should be appreciated that according to exemplary embodiments, in addition to image monitor 230, microwave appliance may further include a user interface panel and/or additional displays. Controller 130 may be mounted within cabinet 150, may be mounted within or be a part of image monitor 230, or may be positioned and integrated in any other suitable manner.

In some embodiments, controller 130 includes one or more memory devices and one or more processors. The processors can be any combination of general or special purpose processors, CPUs, or the like that can execute programming instructions or control code associated with operation of microwave appliance 102. The memory devices (i.e., memory) may represent random access memory such as DRAM or read only memory such as ROM or FLASH. In one embodiment, the processor executes programming instructions stored in memory. The memory may be a separate component from the processor or may be included onboard within the processor. Alternatively, controller 130 may be constructed without using a processor, for example, using a combination of discrete analog or digital logic circuitry (such as switches, amplifiers, integrators, comparators, flip-flops, AND gates, and the like) to perform control functionality instead of relying upon software.

In certain embodiments, controller 130 includes a network interface such that controller 130 can connect to and communicate over one or more networks with one or more network nodes. Controller 130 can also include one or more transmitting, receiving, or transceiving components for transmitting/receiving communications with other devices communicatively coupled with microwave appliance 102. Additionally, or alternatively, one or more transmitting, receiving, or transceiving components can be located off board controller 130. Generally, controller 130 can be positioned in any suitable location throughout microwave appliance 102. For example, controller 130 may be located proximate door assembly 170 toward the front portion of microwave appliance 102.

According to exemplary embodiments, image monitor 230 may be mounted within the monitor cradle such that image monitor 230 sits on top of or flush with door frame 220. In this regard, imaging surface 234 may extend the entire width and height of door assembly 170 and may provide a clean look and larger interactive surface for the consumer. According to still other embodiments, door frame 220 may be a thin frame that encases image monitor 230, e.g., such that a front end of image monitor 230 sits in the same transverse plane as a front end of door frame 220, e.g., flush with one another.

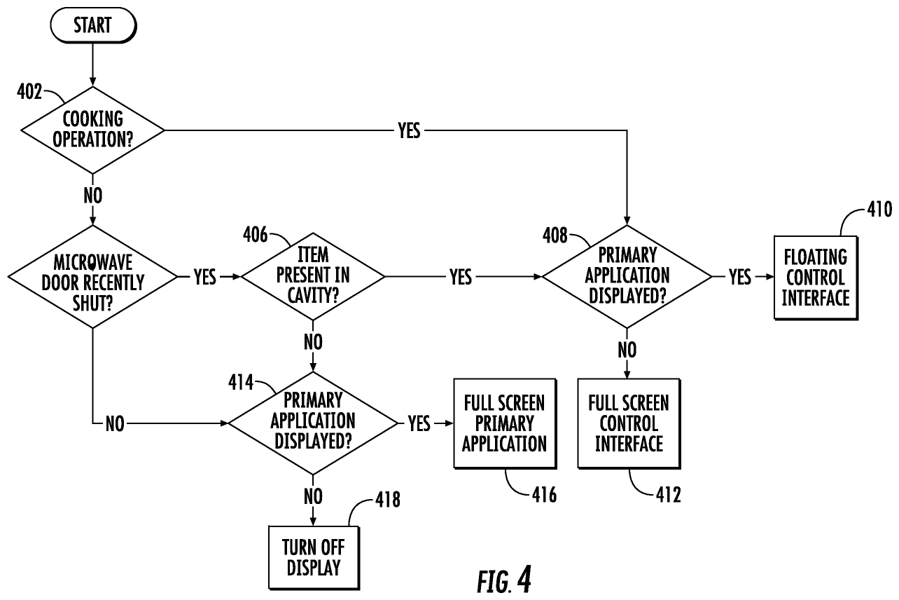

FIG. 4 provides a flow chart illustrating a method of operating an appliance according to exemplary embodiments. In one example, the method may be used to operate a microwave appliance, as described above. However, it should be understood that the method may be applied to a variety of appliances, such as refrigerators, ovens, etc. With reference to FIG. 4, at step 402, the method may determine whether the microwave is currently in operation. For instance, the controller may determine whether or not the microwave is performing a cooking operation. In this instance, a cooking operation may involve an operation of the heating element (e.g., the magnetron) within the microwave cavity. Accordingly, the controller may determine that the microwave is performing a cooking operation by determining that the heating element is activated. It should be understood that the controller may determine that the microwave is performing a cooking operation by using a variety of methods, and that the disclosure is not limited to those examples provided herein. When the controller determines that the microwave is not in operation, the method proceeds to step 404. When the controller determines that the microwave is in operation, the method proceeds to step 408.

At step 404, the method may determine whether the microwave door is shut. In detail, the door sensor may sense a position of the door (i.e., a shut position or an open position). The door sensor may be any suitable sensor capable of sensing position, such as a contact sensor, a hall effect sensor, or a photo optic sensor, for example. The type of sensor used in this method is not limited to those described herein. The controller may further determine a length of time for which the door has been shut. For instance, when the door has been shut for longer than a predetermined length of time, the method proceeds to step 414. When the door has been shut for less than the predetermined length of time, the method proceeds to step 406. The predetermined length of time may be about 10 seconds, may be about 5 seconds, may be about 3 seconds. It should be understood that any suitable length of time may be used as the predetermined length of time.

At step 406, the method may further determine whether an item is present within the cavity of the microwave. For example, at step 406, a camera provided within the cavity may capture an image of the cavity after the microwave door has been shut. The controller may then analyze the image and determine the presence of an item in the cavity. In this instance, the item may be a food item, dishware (e.g., cups, plates, etc.), or other reheatable items (e.g., medical gel packs). The controller may determine that when an item is present within the cavity, a user is intending to operate the microwave (i.e., the heating element). Additionally or alternatively, the controller may analyze the image using an artificial intelligence algorithm. For example, the artificial intelligence algorithm may determine what the item is within the cavity and suggest appropriate cooking operations to the user. In alternate embodiments, the controller may determine that an item is present within the cavity by alternate methods, such as a weight sensor, a temperature sensor, or the like. When the controller determines the presence of an item within the cavity, the method proceeds to step 408. When the controller determines that there is no item within the cavity, the method proceeds to step 414.

At step 408, the method may further determine whether a primary application is displayed on the display panel of the microwave door. As used herein, the term “primary application” and the like is generally intended to refer to the display of content on the image monitor other than the control panel display, or control interface. For example, the primary application may refer to an optically-viewable picture or video, recipe guide, video of the cavity, etc. However, it should be appreciated that the primary application is distinct from the control panel display, as described in more detail below. When the controller determines that a primary application is displayed, the method proceeds to step 410. When the controller determines that a primary application is not displayed, the methods proceeds to step 412.

At step 410, the controller may display a floating control interface. In other words, the controller may display the control interface over a portion or sub-portion of the display, for example, a sub-portion of the primary application. As used herein, the term “control interface” and the like is intended to refer to the interface or control panel through which a user interacts with or operates the microwave. However, it should be appreciated that the control interface is distinct from the primary application, as described below. In detail, when the controller determines that the door has been shut within the predetermined amount of time, determines that an item is present within the cavity, and determines that a primary application is displayed on the display, the controller displays a control interface for controlling an operation of the microwave over a sub-portion of the display (i.e., a sub-portion of the primary application). The control interface may include controls to operate the microwave, including number buttons, cooking operations buttons (i.e., reheat, defrost, etc.), food item buttons (i.e., popcorn, meat, potato, etc.), and power level buttons, for example. The control interface may include a sub-display that displays information regarding to the cooking operation, such as time remaining, power level selected, or size/weight of a food item.

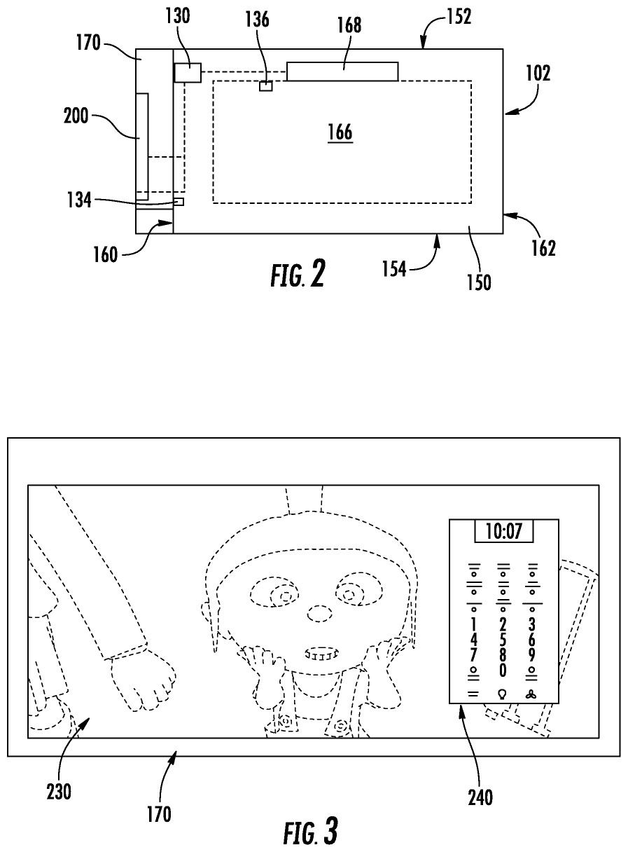

The control interface may have any suitable size and shape. In one example, the control interface may be rectangular, as shown in FIG. 3, however any suitable shape may be implemented for the control interface. In at least some embodiments, outer dimensions of the control interface are smaller than outer dimensions of the display. For example, a height and width of the control interface may be smaller (i.e., shorter) than a height and width of the display. Accordingly, the control interface is not displayed over the entire display, and therefore the control interface is not displayed over the entire primary application. For example, a relative screen coverage of the control interface may be smaller than a relative screen coverage of the primary application. In some embodiments, the display may be split between the primary application and the control interface. The control interface may be operable as a touch interface. Thus, when the control interface is displayed over a sub-portion of the display, the controller may manipulate the subsequent sub-portion to respond to touch inputs from the user to operate the microwave or appliance, without unduly impacting the user's ability to view or observe the primary application.

Additionally or alternatively, the control interface may be moved on the display. In detail, a user may alter a placement of the control interface on the display to a desired location. For instance, the control interface may be placed in any suitable location on the display according to the desire of the user and in order to maximize viewability of the primary application. Additionally or alternatively, a size of the control interface may be altered as desired by the user. For instance, a user may increase or decrease the outer dimensions (i.e., height and width) of the control interface as desired to maximize a viewable area of the primary application. This movement and resizing may be performed by a user, for example, by pressing and dragging, pinching or expanding fingertips, etc. Notably, the primary application may remain active in the background, e.g., covering space previously occupied by the control interface, etc.

At step 412, the controller may display the control interface on the full display panel. In detail, when the controller determines that the door has recently been shut, an item is present in the cavity, and a primary application is not displayed on the display, the controller may utilize the entire display to display the control interface. Accordingly, the controller may utilize more space on the display to display the control interface and accordingly display more detailed controls or larger control buttons to increase usability of the appliance. For example, expanded interactive buttons may be shown on the full screen, such as more complicated cooking procedures (e.g., complex defrost, multi-level cooking, etc.) or dual control displays such as a cooking time countdown as well as an additional timer countdown for other unrelated operations. Additionally or alternatively, the user may alter the size of the control interface to a desired size and, as mentioned above, alter a placement or location of the control interface on the display to a desired location.

Returning to step 414, when the controller determines that the microwave is not currently in a cooking operation (e.g., the heating element is not active), the door has not been recently shut (e.g., the predetermined amount of time has past since the door has been shut), and/or there is no item present in the cavity, the method may determine whether a primary application is displayed. The primary application is described above, and as such a repeat description will be omitted. When the controller determines that a primary application is displayed, the method proceeds to step 416. At step 416, the method includes displaying the primary application on the full screen of the display. When the controller determines that a primary application is not displayed, the method proceeds to step 418. At step 418, the method includes turning off the display. In detail, when the appliance is not in operation and a primary application is not displayed, the controller may automatically fully turn off the display.

In some examples, a user may be able to change what is displayed on the display. For example, a user may alternate between displaying a primary application, a camera view of the cavity, and the control interface on the display. A user may be able to perform the change at any time. For example, when the appliance is in operation and a primary application is displayed, a user may change the display to view the cavity instead of the primary application. In another example, when the appliance is in operation, a user may change the display to view a full-size image of the control interface. Further, a user may alternate between any of the displays at any time.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for operating a door assembly of an appliance, the door assembly including a display and being configured for providing selective access to a cavity of the appliance, the method comprising:
determining that the door has been shut;
determining that an item is present within the cavity;
determining that a primary application is displayed on the display; and
displaying a control interface over a sub-portion of the primary application on the display when the application is displayed on the display.

2. The method of claim 1, wherein determining that the item is present comprises:
obtaining an image of the cavity using a camera; and
analyzing the image to determine whether the food item is present within the cavity.

3. The method of claim 2, wherein analyzing the image to determine whether the item is present within the cavity comprises analyzing the image using an artificial intelligence algorithm.

4. The method of claim 1, further comprising turning off the display when the door has been shut for a predetermined amount of time, no item is present within the cavity, and no primary application is displayed on the display.

5. The method of claim 1, further comprising:
determining that the microwave is performing a cooking operation; and
displaying only the control interface on the display when the primary application is not displayed.

6. The method of claim 1, wherein a location of the control interface is movable on the display.

7. The method of claim 1, wherein the display is changeable among a full control display, a primary application display, and an interior view of the cavity.

8. The method of claim 1, wherein the display is a touch enabled display screen.

9. The method of claim 1, wherein the appliance is a microwave oven.

10. A kitchen appliance, comprising:
a cabinet defining a cavity for receipt of items;
a door attached to the cabinet to selectively open and close the cavity;
a display provided on the door; and
a controller for controlling the display, the controller configured for:
determining that the door has been shut;
determining that an item is present within the cavity;
determining that a primary application is displayed on the display; and
displaying a control interface over a sub-portion of the primary application on the display when the application is displayed on the display.

11. The kitchen appliance of claim 10, wherein determining that the item is present comprises:
obtaining an image of the cavity using a camera; and
analyzing the image to determine whether the food item is present within the cavity.

12. The kitchen appliance of claim 11, wherein analyzing the image to determine whether the item is present within the cavity comprises analyzing the image using an artificial intelligence algorithm.

13. The kitchen appliance of claim 10, wherein the controller is further configured for turning off the display when the door has been shut for a predetermined amount of time, no item is present within the cavity, and no primary application is displayed on the display.

14. The kitchen appliance of claim 10, wherein the controller is further configured for:
determining that the microwave is performing a cooking operation; and
displaying only the control interface on the display when the primary application is not displayed.

15. The kitchen appliance of claim 10, wherein a location of the control interface is movable on the display.

16. The kitchen appliance of claim 10, wherein the display is changeable among a full control display, a primary application display, and an interior view of the cavity.

17. The kitchen appliance of claim 10, wherein the display is a touch enabled display screen.

18. The kitchen appliance of claim 10, wherein the kitchen appliance is a microwave oven.
